(19) United States
(12) Patent Application Publication
(10) Pub. No.: US 2025/0334004 A1
(43) Pub. Date: Oct. 30, 2025

(54) CURTAIN DRILLING-FREE ELECTRIC MOUNTING DEVICE AND TOP BEAM MOUNTING ASSEMBLY THEREOF

(71) Applicant: NINGBO LIYANG NEW MATERIAL COMPANY LIMITED, Ningbo City (CN)

(72) Inventors: Baoguo TAN, Ningbo City, Zhejiang Province (CN); Jianhong WEI, Ningbo City, Zhejiang Province (CN)

(21) Appl. No.: 18/886,159

(22) Filed: Sep. 16, 2024

(30) Foreign Application Priority Data
Apr. 26, 2024 (CN) 202410518490.8

(51) Int. Cl. E06B 9/56

(52) U.S. Cl. CPC E06B 9/56

(57) ABSTRACT

The present disclosure discloses a curtain drilling-free electric mounting device and a top beam mounting assembly thereof, which comprises a housing with accommodation chamber disposed inside; an electric drive module, a locking module and a telescoping adjusting module are sequentially disposed inside. The electric drive module is fixedly disposed inside the accommodation chamber. One end of the locking module is connected with a power output end of the electric drive module and the other end connected with the telescoping adjusting module. An end of the telescoping adjusting module away from the locking module is exposed outside the housing to abut against a mounting surface for pre-positioning. The telescoping adjusting module has a telescoping adjusting length. The electric drive module drives the locking module to lock or unlock the telescoping adjusting module. In a locked state, a length that the telescoping adjusting module protrudes out of the housing is fixed.

This application is based upon and claims priority to Chinese Patent Application No. 202410518490.8, filed on April 26^{th}, 2024, the entire contents of which are incorporated herein by reference.

### TECHNICAL FIELD

The present disclosure relates to the field of curtain technologies and in particular to a curtain drilling-free electric mounting device and a top beam mounting assembly thereof.

### BACKGROUND

The curtains are widely applied in the locations such as homes and offices to adjust indoor light. The curtains commonly used nowadays include roller blinds, venetian blinds and honeycomb blinds. Generally, these curtains are fixedly mounted on window frames by mounting brackets and screws during mounting process. Since it is required to open screw holes on the window frames for mounting the curtains, when remounting or change of the curtains is required, new screw holes are to be opened without using the original ones, which will inevitably leave many screw holes on the walls of the window frames, damaging the walls and affecting the aesthetics. Further, drilling and mounting will consume much time and labor and also produce dusts which are difficult to clean. Although there appear many mountable-without-drilling curtains on the markets, the existing drilling-free mounting components are to be operated manually during use, and are basically supported on the window frames by elastic assembling, and then locked and limited by manual adjustment. People have to climb to the mounting height for manual mounting and adjustment because the mounting positions of the curtains mostly have a given mounting height. Therefore, the manual operation is time-consuming, labor-consuming and troublesome, leading to low mounting efficiency.

### SUMMARY

In order to solve the above technical problems in the prior arts, the present disclosure provides a curtain drilling-free electric mounting device and a top beam mounting assembly thereof, so as to electrically control the drilling-free mounting of a curtain, increasing the mounting efficiency and saving time and labor.

In order to address the above technical problems, the present disclosure employs the following technical solution: there is provided a curtain drilling-free electric mounting device, which comprises a housing. An accommodation chamber is disposed inside the housing, and an electric drive module for supplying power, a locking module and a telescoping adjusting module are sequentially disposed inside the accommodation chamber. The electric drive module is fixedly disposed inside the accommodation chamber. One end of the locking module is connected with a power output end of the electric drive module and the other end of the locking module is connected with the telescoping adjusting module. An end of the telescoping adjusting module away from the locking module is exposed outside the housing to abut against a mounting surface for pre-positioning. The telescoping adjusting module has a telescoping adjusting length. The electric drive module drives the locking module to lock or unlock the telescoping adjusting module. In a locked state, a length that the telescoping adjusting module protrudes out of the housing is fixed, and in an unlocked state, the telescoping adjusting module can arbitrarily adjust the length that it protrudes out of the housing within its telescoping adjusting length.

Furthermore, the housing comprises a housing body and an end cover detachably connected with the housing body. A limiting piece detachably connected with the end cover is fixedly disposed at an end of the housing body. The electric drive module is fixedly disposed away from the limiting piece inside the accommodation chamber of the housing body. A stop part in cooperation with the limiting piece to stop the telescoping adjusting module from axially slipping out of the housing is disposed on the telescoping adjusting module.

Furthermore, the telescoping adjusting module comprises an ejection rod, an ejection block and a first spring; and the locking module comprises a screw rod, a first slide block, a second slide block, and a locking assembly. The ejection rod, from outside to inside, sequentially penetrates through the ejection block, the first spring, the end cover, the limiting piece, the second slide block and the first slide block. The screw rod is in transmission connection with the power output end of the electric drive module. The first slide block is in thread transmission connection with the screw rod. The locking assembly is mounted inside the second slide block to embrace or separate from the ejection rod. The stop part is integrally formed on the ejection rod. In a natural state, the first spring squeezes toward both ends, that is, one end of the first spring is abutted against an inner end surface of the ejection block, and the other end is abutted against an inner end surface of the end cover. The stop part is abutted against the limiting piece.

Furthermore, the locking assembly comprises a first embrace block, a second embrace block and an elastic piece; a first channel for sleeving the ejection rod is disposed in the second slide block, and a second channel for perpendicularly intersecting with the first channel and mounting the first embrace block and the second embrace block is further disposed in the second slide block. The first embrace block and the second embrace block are symmetrically disposed inside the second channel. The ejection rod is penetrated between the first embrace block and the second embrace block. The elastic piece is disposed between the first embrace block and the second embrace block. When the first embrace block and the second embrace block are squeezed by forces of opposite directions, the first embrace block and the second embrace block are moved close to each other to embrace the ejection rod; when the forces of opposite directions are cancelled, the elastic piece pushes the first embrace block and the second embrace block in opposite directions to separate from the ejection rod.

Furthermore, the elastic piece includes two springs, which are disposed as one group between the first embrace block and the second embrace block. The springs are symmetrically located at lower and upper sides of the ejection rod. Spring grooves for mounting the springs are disposed on the first embrace block and the second embrace block respectively.

Furthermore, symmetrical extension arms are formed at both sides of the limiting piece, and trapezoid grooves are disposed on two sides of the extension arms; trapezoid blocks matching the corresponding trapezoid grooves are disposed on the first embrace block and the second embrace block respectively.

Furthermore, an embrace segment is disposed on the ejection rod, and multiple equidistantly-arranged clamping teeth are disposed at both sides of the embrace segment respectively; U-shaped grooves for the ejection rod to run through are disposed respectively on the first embrace block and the second embrace block, and clamping tooth surfaces fitted to the clamping teeth are respectively disposed on bottom surfaces of the U-shaped grooves. In a locked state, the first embrace block and the second embrace block embrace the ejection rod and the clamping tooth surfaces are respectively fitted to the clamping teeth of the embrace segment. In an unlocked state, the first embrace block and the second embrace block separate from the ejection rod, and the ejection rod can be movable between the two opposed U-shaped grooves.

Furthermore, the telescoping adjusting module further comprises a second spring, which is sleeved on the ejection rod and located between the first slide block and the second slide block. The first spring has a smaller elastic force than the second spring.

Furthermore, a first signal switch is disposed at an end of the first slide block close to the electric drive module, and a second signal switch is disposed at an end of the first slide block close to the second slide block. The first signal switch is used to sense a travel position of the first slide block for retreating unlocking and the second signal switch is used to sense a travel position of the first slide block for advancing locking.

Furthermore, the electric drive module is a motor.

There is provided a top beam mounting assembly, which comprises a top beam. One end of the top beam is connected with the above curtain drilling-free electric mounting device, and the other end of the top beam is connected with a sealing cover.

Compared with the prior arts, the present disclosure has the following advantages: in the present disclosure, pre-positioning mounting is carried out by the telescoping adjusting length of the telescoping adjusting module, and then the electric drive module drives the locking module to embrace the telescoping adjusting module to achieve the fixing effect so as to complete the mounting. During dismounting process, the electric drive module drives the locking module to withdraw the squeeze and hence release the embrace on the telescoping adjusting module in an elastic resetting way, such that the telescoping adjusting module can extend or retract for an adjusting length, so as to dismount the curtain. In this process, the electric drive module can electrically complete locking and unlocking operations without human operations, bringing use conveniences and saving time and labor.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of the present disclosure.

FIG. 2 is a structural schematic diagram illustrating a disassembled housing according to the present disclosure.

FIG. 3 is an exploded view of the present disclosure.

FIG. 4 is a front sectional view of the present disclosure.

FIG. 5 is a left sectional view of the present disclosure.

FIG. 6 is a top sectional view of the present disclosure.

FIG. 7 is a top sectional view deeper than FIG. 6.

FIG. 8 is a structural schematic diagram illustrating a top beam mounting assembly according to the present disclosure.

The numerals of the drawings are described below: 1. housing, 1.1 housing body, 1.2 end cover, 1.3 accommodation chamber, 2. electric drive module, 3. ejection rod, 3.1 stop part, 3.2 embrace segment, 3.3 clamping tooth, 4. ejection block, 5. first spring, 6. second spring, 7. screw rod, 8. first slide block, 9. second slide block, 9.1 first channel, 9.2 second channel, 10. first embrace block, 10.1 spring groove, 10.2 trapezoid block, 10.3 U-shaped groove, 10.4 clamping tooth surface, 11. second embrace block, 11.1 spring groove, 11.2 trapezoid block, 11.3 U-shaped groove, 11.4 clamping tooth surface, 12. elastic piece, 13. limiting piece, 13.1 extension arm, 13.2 trapezoid groove, 14. first signal switch, 15. second signal switch, 16. top beam and 17. sealing cover.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

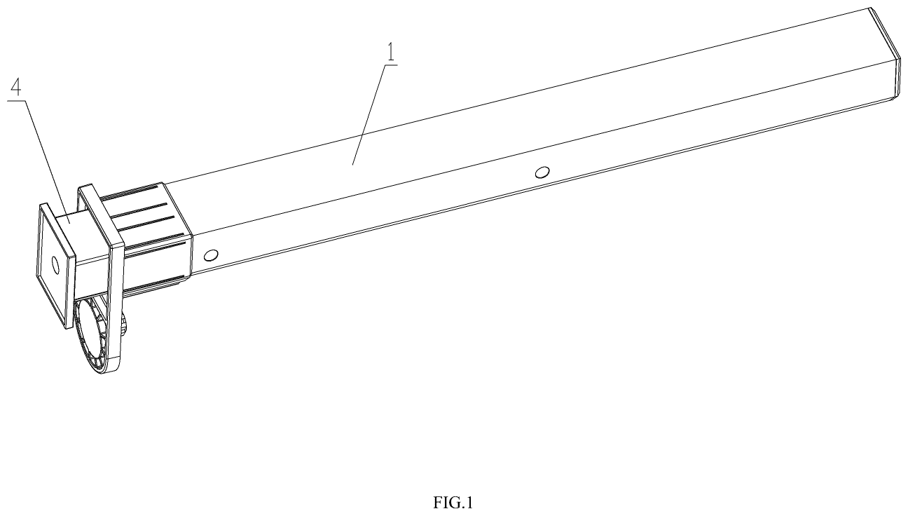

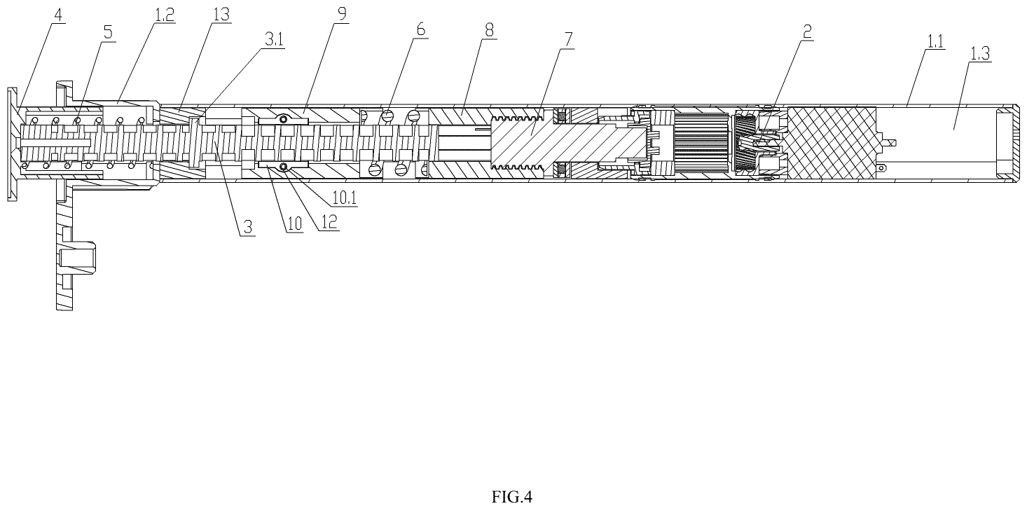

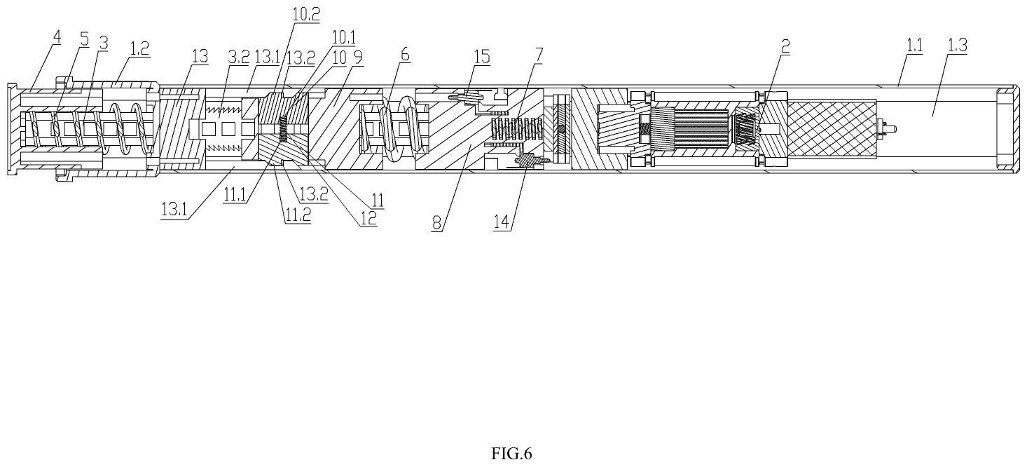

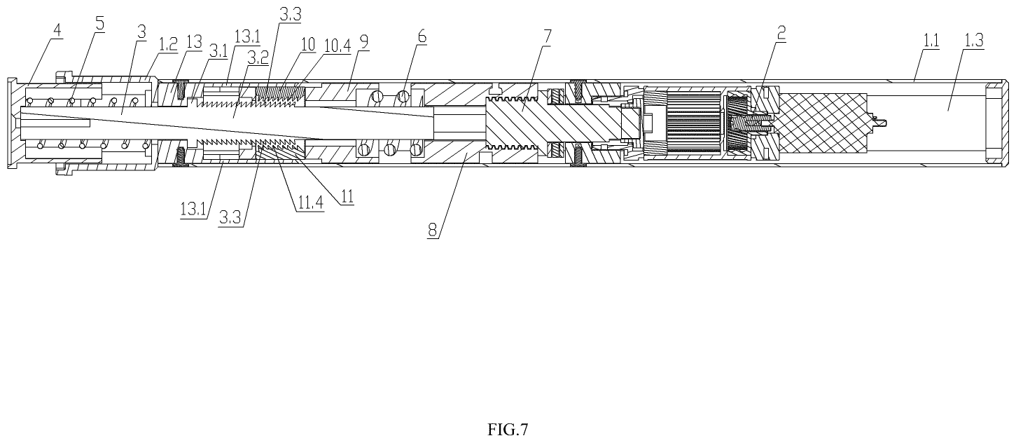

As shown in FIGS. 1 to 7, the present disclosure provides a curtain drilling-free electric mounting device, which comprises a housing 1. An accommodation chamber 1.3 is disposed inside the housing 1, and an electric drive module 2 for supplying power, a locking module and a telescoping adjusting module are sequentially disposed inside the accommodation chamber 1.3. The electric drive module 2 is fixedly disposed inside the accommodation chamber 1.3. One end of the locking module is connected with a power output end of the electric drive module 2 and the other end of the locking module is connected with the telescoping adjusting module. An end of the telescoping adjusting module away from the locking module is exposed outside the housing 1 to abut against a mounting surface for pre-positioning. The telescoping adjusting module has a telescoping adjusting length. The electric drive module 2 drives the locking module to lock or unlock the telescoping adjusting module. In a locked state, a length that the telescoping adjusting module protrudes out of the housing is fixed, and in an unlocked state, the telescoping adjusting module can arbitrarily adjust the length it protrudes out of the housing within its telescoping adjusting length.

In the present disclosure, pre-positioning mounting is carried out by the telescoping adjusting length of the telescoping adjusting module, and then the electric drive module 2 drives the locking module to embrace the telescoping adjusting module to achieve the fixing effect so as to complete the mounting. During dismounting process, the electric drive module 2 drives the locking module to withdraw the squeeze and hence release the embrace on the telescoping adjusting module in an elastic resetting way, such that the telescoping adjusting module can extend or retract for the adjusting length, so as to dismount the curtain. In this process, the electric drive module 2 can electrically complete locking and unlocking operations without human operations, bringing use conveniences and saving time and labor.

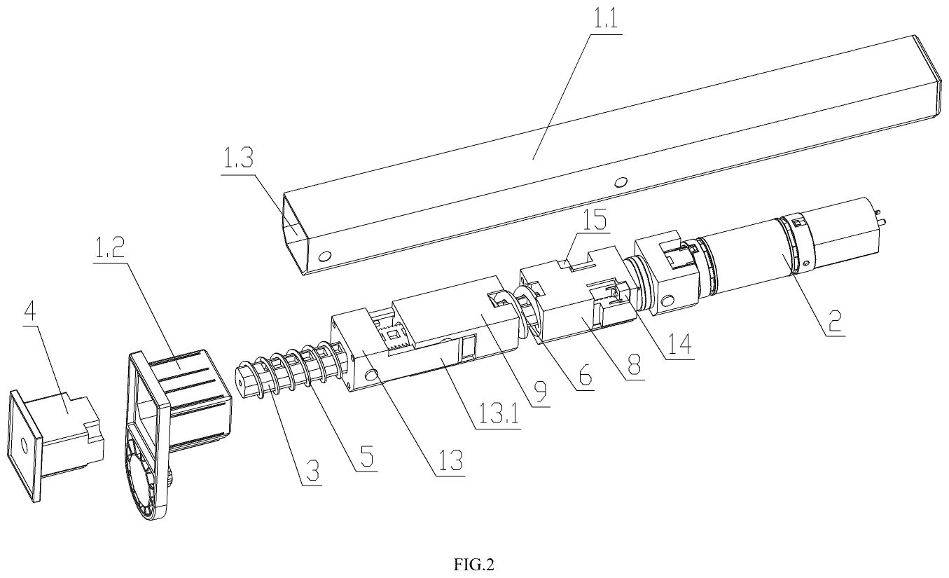

With reference to FIG. 2, the housing 1 comprises a housing body 1.1 and an end cover 1.2 detachably connected with the housing body 1.1. The detachable connection of the end cover 1.2 can facilitate the assembling operation and help the change operation to adapt to different types of curtain top beams. A limiting piece 13 detachably connected with the end cover 1.2 is fixedly disposed at an end of the housing body 1.1. The disposal of the limiting piece 13 can not only achieve medium connection effect but also reduce damage to the housing body 1.1. The electric drive module 2 is fixedly disposed away from the limiting piece 13 inside the accommodation chamber 1.3 of the housing body 1.1. A stop part 3.1 in cooperation with the limiting piece 13 to stop the telescoping adjusting module from axially slipping out of the housing 1 is disposed on the telescoping adjusting module. The disposal of the limiting piece 13, on the one hand, facilitates the detachable connection of the end cover 1.2 and the change operation, and on the other hand, achieves the axial limiting and stopping effect so as to limit the telescoping adjusting module from axially slipping out of the housing 1.

With reference to FIGS. 2, 3, and 4, the telescoping adjusting module comprises an ejection rod 3, an ejection block 4 and a first spring 5; and the locking module comprises a screw rod 7, a first slide block 8, a second slide block 9, and a locking assembly. The ejection rod 3, from outside to inside, sequentially penetrates through the ejection block 4, the first spring 5, the end cover 1.2, the limiting piece 13, the second slide block 9 and the first slide block 8. The ejection block 4 is fixed by screws on an end of the ejection rod 3 to abut against the mounting surface. The screw rod 7 is in transmission connection with the power output end of the electric drive module 2. The first slide block 8 is in thread transmission connection with the screw rod 7. The locking assembly is mounted inside the second slide block 9 to embrace or separate from the ejection rod 3. The stop part 3.1 is integrally formed on the ejection rod 3. In a natural state, the first spring 5 squeezes toward both ends, that is, one end of the first spring 5 is abutted against an inner end surface of the ejection block 4, and the other end is abutted against an inner end surface of the end cover 1.2. The stop part 3.1 is abutted against the limiting piece 13. In a natural state, the first spring 5 pushes the ejection block 4 to slide out of the end cover 1.2 by a maximal distance, where the maximal distance is a maximal telescoping adjusting length of the drilling-free electric mounting device. During adjustment, the ejection block 4 is squeezed inwardly to compress the first spring 5 so as to carry out pre-positioning mounting, and then the electric drive module 2 drives rotation of the screw rod 7 and the screw rod 7 drives the first slide block 8 to move axially along the screw rod 7 to push the second slide block 9, and thus the second slide block 9 drives the locking assembly to move until the locking assembly embraces the ejection rod 3, completing the locking and mounting. Since the telescoping length can be adjusted, the mounting adaptability is broadened. Moreover, multiple types of curtain top beams can be matched to adapt to various sizes of windows. Further, electric mounting can also be achieved, saving labor and time.

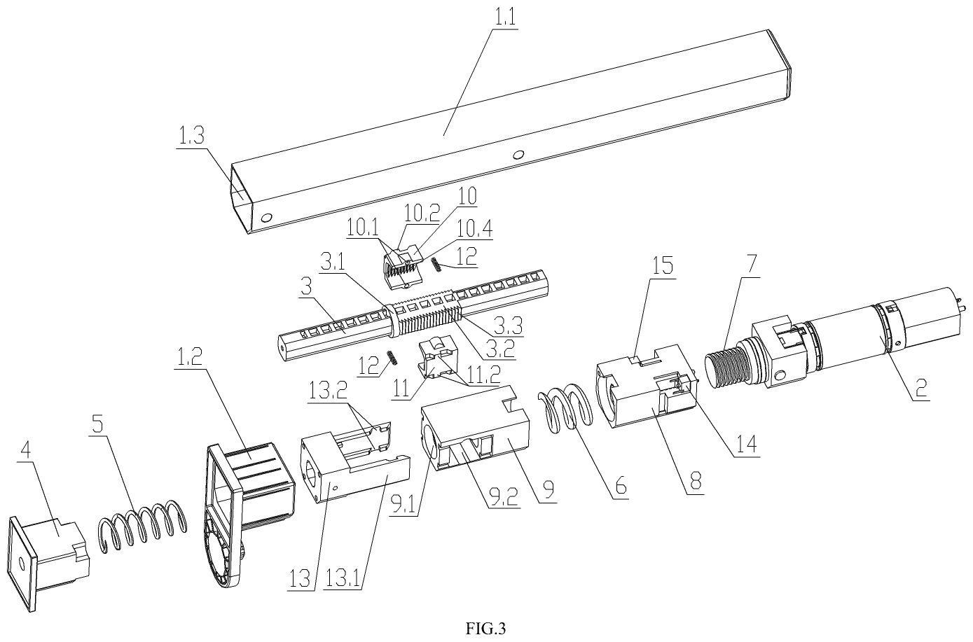

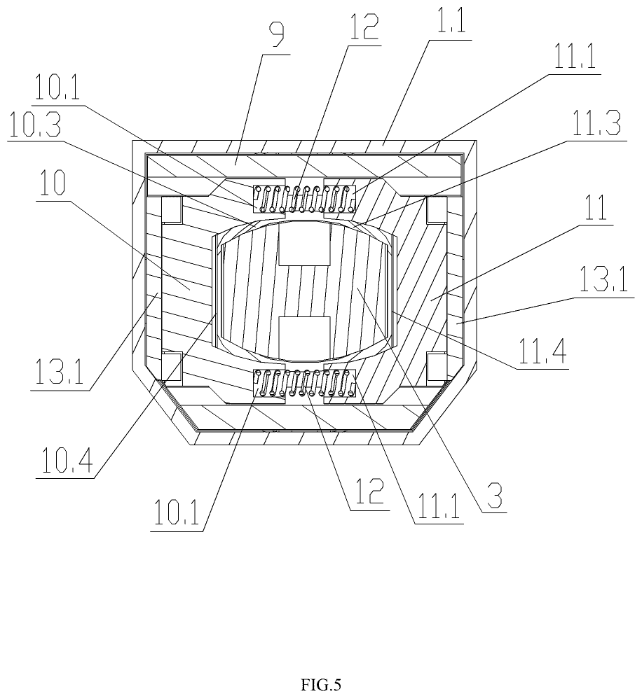

With reference to FIG. 3, the locking assembly comprises a first embrace block 10, a second embrace block 11 and an elastic piece 12; a first channel 9.1 for sleeving the ejection rod 3 is disposed in the second slide block 9, and a second channel 9.2 for perpendicularly intersecting with the first channel 9.1 and mounting the first embrace block 10 and the second embrace block 11 is further disposed in the second slide block 9. The first embrace block 10 and the second embrace block 11 are symmetrically disposed inside the second channel 9.2. The ejection rod 3 is penetrated between the first embrace block 10 and the second embrace block 11. The elastic piece 12 is disposed between the first embrace block 10 and the second embrace block 11. When the first embrace block 10 and the second embrace block 11 are squeezed by forces of opposite directions, the first embrace block 10 and the second embrace block 11 are moved close to each other to embrace the ejection rod 3; when the forces of opposite directions are cancelled, the elastic piece 12 pushes the first embrace block 10 and the second embrace block 11 in opposite directions to separate from the ejection rod 3. In this way, the first embrace block 10 and the second embrace block 11 can be moved close to each other or away from each other to achieve the embrace-locking or separation-unlocking for the ejection rod 3. This structure disposal can achieve better locking effect. In the locked state, more stable structure and more secure mounting can be achieved, so as to avoid separation due to long time of use. With reference to FIG. 5, the elastic piece 12 includes two springs, which are disposed as one group between the first embrace block 10 and the second embrace block 11. The springs are symmetrically located at lower and upper sides of the ejection rod 3 to avoid the ejection rod 3, not obstructing the axial movement of the ejection rod 3. Spring grooves 10.1 and 11.1 for mounting the springs are disposed on the first embrace block 10 and the second embrace block 11 respectively.

With reference to FIGS. 2, 3, and 6, symmetrical extension arms 13.1 are formed at both sides of the limiting piece 13, and trapezoid grooves 13.2 are disposed on two sides of the extension arms 13.1; trapezoid blocks 10.2 and 11.2 matching the corresponding trapezoid grooves 13.2 are disposed on the first embrace block 10 and the second embrace block 11 respectively. Inclined surface cooperation between the trapezoid grooves 13.2 and the trapezoid blocks 10.2 and 11.2 can achieve radial push for the first embrace block 10 and the second embrace block 11. For example, When the second slide block 9 is pushed forward, the first embrace block 10 and the second embrace block 11 are moved together and hence inclined surfaces of the trapezoid blocks 10.2 and 11.2 respectively located on the first embrace block 10 and the second embrace block 11 may slide along inclined surfaces of the corresponding trapezoid grooves 13.2 such that the first embrace block 10 and the second embrace block 11 are radially pushed to move close to each other, so as to embrace the ejection rod 3. At this time, the springs between the first embrace block 10 and the second embrace block 11 are compressed. When the second slide block 9 is not pushed radially, the springs between the first embrace block 10 and the second embrace block 11 push the first embrace block 10 and the second embrace block 11 to move away from each other, and the trapezoid blocks 10.2 and 11.2 respectively located on the first embrace block 10 and the second embrace block 11 are reset to the corresponding trapezoid grooves 13.2 along the corresponding inclined surfaces. In this case, the first embrace block 10 and the second embrace block 11 separate from the ejection rod 3. Quick locking and unlocking can be achieved by radial squeeze and resetting. Therefore, the structure is simple and compact.

With reference to FIGS. 3, 5, and 7, an embrace segment 3.2 is disposed on the ejection rod 3, and multiple equidistantly-arranged clamping teeth 3.3 are disposed at both sides of the embrace segment 3.2 respectively; U-shaped grooves 10.3 and 11.3 for the ejection rod 3 to run through are disposed respectively on the first embrace block 10 and the second embrace block 11, and clamping tooth surfaces 10.4 and 11.4 fitted to the clamping teeth 3.3 are respectively disposed on bottom surfaces of the U-shaped grooves 10.3 and 11.3. In a locked state, the first embrace block 10 and the second embrace block 11 embrace the ejection rod 3 and the clamping tooth surfaces 10.4 and 11.4 are respectively fitted to the clamping teeth 3.3 of the embrace segment 3.2, so as to lock the axial movement of the ejection rod 3. In an unlocked state, the first embrace block 10 and the second embrace block 11 separate from the ejection rod 3, and the ejection rod 3 can be movable between the two opposed U-shaped grooves 10.3 and 11.3, so as to release the ejection rod 3 to axially move. The disposal of the clamping teeth 3.3 and the clamping tooth surfaces 10.4 and 11.4 can achieve simple, quick and accurate fitting.

With reference to FIGS. 2, 3, 4, 6, and 7, the telescoping adjusting module further comprises a second spring 6, which is sleeved on the ejection rod 3 and located between the first slide block 8 and the second slide block 9. The first spring 5 has a smaller elastic force than the second spring 6. The first spring 5 is slenderer and smaller in elastic force whereas the second spring 6 is stubbier and larger in elastic force. The disposal of the first spring 5 helps push the ejection rod 3 elastically to achieve pre-positioning mounting and the telescoping length can be adjusted easily by squeeze due to smaller elastic force. The disposal of the second spring 6 can further achieve the effect of elastic travel compensation, for example, the second spring 6 can perform elastic displacement compensation at any time especially when loosening and falling off occur due to deformation resulting from long time of fixed mounting. In this way, the curtain is prevented from falling off after long time of use. For example, when the ejection block 4 on the ejection rod 3 is abutted against the mounting surface to achieve pre-mounting, the electric drive module 2 drives the screw rod 7 and hence drives the first slide block 8 to push the second spring 6, and the second spring 6 pushes the second slide block 9 until the first embrace block 10 and the second embrace block 11 on the second slide block 9 embrace the ejection rod 3. At this time, the first embrace block 10 and the second embrace block 11 are locked to the ejection rod 3, and the ejection rod 3 is ejected against the mounting surface, and at this time the second slide block 8 also stops moving forward. But the first slide block 8 continues moving forward to squeeze the second spring 6 until locking up and the electric drive module 2 stops working. If one spring is used alone, when the spring has an excessively small elastic force, although pre-positioning mounting can be achieved by adjusting the telescoping length of the ejection rod 3 easily, the spring may lose its elasticity over a long time of use. Because the elastic abutting may serve for a shorter life, the curtain may easily fall off. When the spring has an excessively large elastic force, the telescoping length of the ejection rod 3 is adjusted with more effort, but the spring can serve for a longer life without causing the curtain to easily fall off. Therefore, the combined use of the first spring 5 and the second spring 6 can not only facilitate achieving pre-positioning mounting by adjusting the telescoping length of the ejection rod 3 but also prevent the falling-off of the curtain resulting from long time of use, ensuring longer and safer service life. In addition, the first spring 5 and the second spring 6 are separately disposed, that is, the first spring 5 is disposed at an end of the ejection rod 3 away from the locking assembly and the second spring 6 is disposed within the locking module and between the first slide block 8 and the second slide block 9, which can reduce a drive travel of the electric drive module 2. Due to small compression range, the locking can be achieved in a shorter time, that is, locking and unlocking can be achieved more quickly. In this case, the electric drive module 2 can be selected as having smaller power, reducing the costs.

With reference to FIGS. 2, 3, and 6, a first signal switch 14 is disposed at an end of the first slide block 8 close to the electric drive module 2, and a second signal switch 15 is disposed at an end of the first slide block 8 close to the second slide block 9. The first signal switch 14 is used to sense a travel position of the first slide block 8 for retreating unlocking and the second signal switch 15 is used to sense a travel position of the first slide block 8 for advancing locking. When the first signal switch 14 and the second signal switch 15 sense a set travel position, the electric drive module 2 can stop working and complete unlocking and locking. The disposal of the first signal switch 14 and the second signal switch 15 can enable the electric drive module 2 to provide controlled unlocking travel and locking travel and thus the second spring 6 is prevented from being excessively compressed and damaging an adjacent component. In this way, the controlled locking force can be provided and the service life can be extended. Further, an optimal drive travel can be provided to the electric drive module 2, and hence the movement distance of the first slide block 8 can be controlled, so as to prevent the electric drive module 2 from excessively driving the screw rod 7 to push the first slide block 8, saving time and power.

The electric drive module 2 is a motor which comprises a motor core and a speed reducer. The motor provides power for the rotation of the screw rod 7 stably and effortlessly, realizing electric operations.

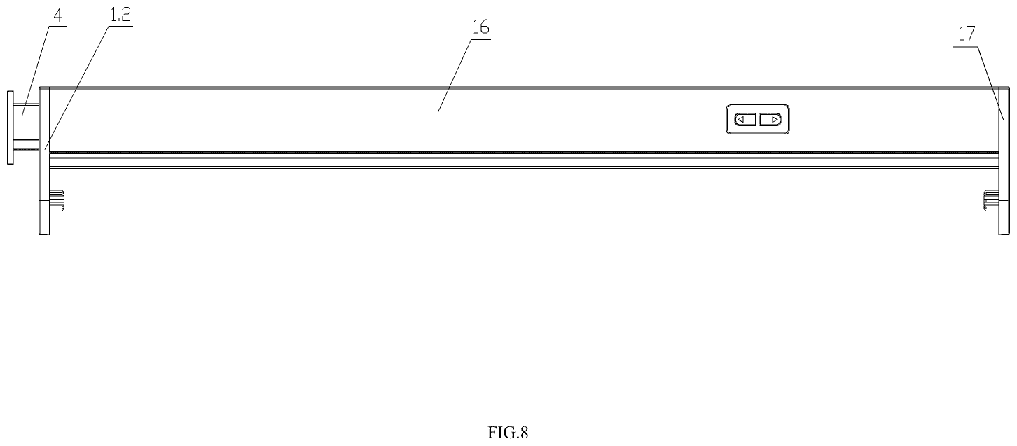

As shown in FIG. 8, there is provided a top beam mounting assembly, which comprises a top beam 16. One end of the top beam 16 is connected with the above curtain drilling-free electric mounting device. The end surface of end cover 1.2 is connected with an end of the top beam 16 in a blocking way. The other end of the top beam 16 is connected with a sealing cover 17. The sealing cover 17 is not limited to an ordinary sealing cover, and can also comprise a side end of a motor device, a power supply device and a transmission device and the like. When the motor device, the power supply device or the transmission device or the like is connected in an insertion way with the top beam, the end of the top beam can be blocked.

During assembling, the curtain drilling-free electric mounting device is connected in an insertion way with one end of the top beam 16, and the other end of the top beam 16 is connected with the sealing cover 17 in an insertion way, and a curtain body may be assembled below the top beam 16. During mounting process, the ejection block 4 is abutted against a mounting wall surface, and the other end of the top beam 16 is abutted against an opposite mounting wall surface. When the ejection block 4 receives the elastic squeeze of the first spring 5, the top beam 16 can be supported on the mounting position so as to complete pre-positioning mounting. Then, the motor starts to drive the rotation of the screw rod 7 and hence the first slide block 8 on the screw rod 7 is slid toward the second slide block 9 along the screw rod 7 while the first slide block 8 pushes the second spring 6 and the second slide block 9. At this time, the first embrace block 10 and the second embrace block 11 in the second slide block 9, when moving in synchronization with the second slide block 9, are radially squeezed by the inclined surfaces of the trapezoid grooves 13.2 on the limiting piece 13, that is, the inclined surfaces of the trapezoid blocks 10.2 and 11.2 can slide relative to the inclined surfaces of the corresponding trapezoid grooves 13.2 to generate radial squeeze such that the first embrace block 10 and the second embrace block 11 are moved close to each other and hence embrace the ejection rod 3. In this case, the clamping tooth surfaces 10.4 and 11.4 of the first embrace block 10 and the second embrace block 11 are respectively fitted to the corresponding clamping teeth 3.3 on the ejection rod 3 and the second slide block 9 stops moving forward. At this time, the first slide block 8 continues sliding toward the second slide block 9 along the screw rod 7 to compress the second spring 6 until the second signal switch 15 on the first slide block 8 senses the travel position of the first slide block 8 for the advancing locking. The motor stops working and the ejection rod 3 is locked against axial movement, thus completing the fixed mounting. After the top beam 16 is used for long, the elastic force of the second spring 6 can sequentially squeeze the second slide block 9, the first embrace block 10, the second embrace block 11, the ejection rod 3, the ejection block 4 such that the ejection block 4 is always abutted against the mounting wall surface, without loosening. In this way, stable mounting is carried out. During dismounting process, the motor rotates reversely to drive the screw rod 7 to rotate reversely and thus the first slide block 8 on the screw rod 7 is moved away from the second slide block 9 along the screw rod 7 until the first signal switch on the first slide block 8 senses the travel position of the first slide block 8 for the retreating unlocking. The motor stops working to release the second spring 6, and hence the second slide block 9 no longer receives the axial squeeze. At this time, the springs between the first embrace block 10 and the second embrace block 11 push the first embrace block 10 and the second embrace block 11 to move away from each other, such that the trapezoid blocks 10.2 and 11.2 respectively located on the first embrace block 10 and the second embrace block 11 are reset to the corresponding trapezoid grooves 13.2 of the limiting piece 13. The first embrace block 10 and the second embrace block 11 separate from the ejection rod 3 to unlock the ejection rod 3. The ejection block 4 can be squeezed to push the ejection rod 3 to axially move and then the top beam 6 can be dismounted from the mounting position. When the ejection rod 3 is locked and unlocked, the motor electrically drives the first slide block 8 to make reciprocating movement and achieve spring resetting unlocking, without manual operation, bringing much convenience and saving time and labor. In addition, the second signal switch 15 on the first slide block 8 can sense the travel position of the first slide block for the advancing locking such that the motor can provide a controlled locking force without excessively squeezing the second spring 6. Moreover, the end cover 1.2 is detachably connected with the limiting piece 13 on the housing 1 and therefore, the end cover 1.2 can be easily changed to adapt to various sizes of top beams 16 and further adapt to different widths of windows, broadening the application scope. Furthermore, the telescoping length can be adjusted to further improve the application scope and realize electric drilling-free mounting, bringing use conveniences and saving time and labor.

The materials, reagents and experimental instruments involved in the embodiments of the present disclosure are all commercially-available products in the curtain field, unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. A curtain drilling-free electric mounting device, wherein it comprises a housing (1); an accommodation chamber (1.3) is disposed inside the housing (1), and an electric drive module (2) for supplying power, a locking module and a telescoping adjusting module are sequentially disposed inside the accommodation chamber (1.3); the electric drive module (2) is fixedly disposed inside the accommodation chamber (1.3); one end of the locking module is connected with a power output end of the electric drive module (2) and the other end of the locking module is connected with the telescoping adjusting module; an end of the telescoping adjusting module away from the locking module is exposed outside the housing (1) to abut against a mounting surface for pre-positioning; the telescoping adjusting module has a telescoping adjusting length; the electric drive module (2) drives the locking module to lock or unlock the telescoping adjusting module; in a locked state, a length that the telescoping adjusting module protrudes out of the housing (1) is fixed, and in an unlocked state, the telescoping adjusting module can arbitrarily adjust the length that it protrudes out of the housing (1) within its telescoping adjusting length.

2. The curtain drilling-free electric mounting device of claim 1, wherein the housing (1) comprises a housing body (1.1) and an end cover (1.2) detachably connected with the housing body (1.1); a limiting piece (13) detachably connected with the end cover (1.2) is fixedly disposed at an end of the housing body (1.1); the electric drive module (2) is fixedly disposed away from the limiting piece (13) inside the accommodation chamber (1.3) of the housing body (1.1); a stop part (3.1) in cooperation with the limiting piece (13) to stop the telescoping adjusting module from axially slipping out of the housing (1) is disposed on the telescoping adjusting module.

3. The curtain drilling-free electric mounting device of claim 2, wherein the telescoping adjusting module comprises an ejection rod (3), an ejection block (4) and a first spring (5); and the locking module comprises a screw rod (7), a first slide block (8), a second slide block (9), and a locking assembly; the ejection rod (3), from outside to inside, sequentially penetrates through the ejection block (4), the first spring (5), the end cover (1.2), the limiting piece (13), the second slide block (9) and the first slide block (8); the screw rod (7) is in transmission connection with the power output end of the electric drive module (2); the first slide block (8) is in thread transmission connection with the screw rod (7); the locking assembly is mounted inside the second slide block (9) to embrace or separate from the ejection rod (3); the stop part (3.1) is integrally formed on the ejection rod (3); in a natural state, the first spring (5) squeezes toward both ends, and one end of the first spring (5) is abutted against an inner end surface of the ejection block (4), and the other end is abutted against an inner end surface of the end cover (1.2); the stop part (3.1) is abutted against the limiting piece (13).

4. The curtain drilling-free electric mounting device of claim 3, wherein the locking assembly comprises a first embrace block (10), a second embrace block (11) and an elastic piece (12); a first channel (9.1) for sleeving the ejection rod (3) is disposed in the second slide block (9), and a second channel (9.2) for perpendicularly intersecting with the first channel (9.1) and mounting the first embrace block (10) and the second embrace block (11) is further disposed in the second slide block (9); the first embrace block (10) and the second embrace block (11) are symmetrically disposed inside the second channel (9.2); the ejection rod (3) is penetrated between the first embrace block (10) and the second embrace block (11); the elastic piece (12) is disposed between the first embrace block (10) and the second embrace block (11); when the first embrace block (10) and the second embrace block (11) are squeezed by forces of opposite directions, the first embrace block (10) and the second embrace block (11) are moved close to each other to embrace the ejection rod (3); when the forces of opposite directions are cancelled, the elastic piece (12) pushes the first embrace block (10) and the second embrace block (11) in opposite directions to separate from the ejection rod (3).

5. The curtain drilling-free electric mounting device of claim 4, wherein the elastic piece (12) is a spring, two of which are disposed as one group between the first embrace block (10) and the second embrace block (11); the springs are symmetrically located at lower and upper sides of the ejection rod (3); spring grooves (10.1, 11.1) for mounting the springs are disposed on the first embrace block (10) and the second embrace block (11) respectively.

6. The curtain drilling-free electric mounting device of claim 4, wherein symmetrical extension arms (13.1) are formed at both sides of the limiting piece (13), and trapezoid grooves (13.2) are disposed on two sides of the extension arms (13.1); trapezoid blocks (10.2, 11.2) matching the corresponding trapezoid grooves (13.2) are disposed on the first embrace block (10) and the second embrace block (11) respectively.

7. The curtain drilling-free electric mounting device of claim 4, wherein an embrace segment (3.2) is disposed on the ejection rod (3), and multiple equidistantly-arranged clamping teeth (3.3) are disposed at both sides of the embrace segment (3.2) respectively; U-shaped grooves (10.3, 11.3) for the ejection rod (3) to run through are disposed respectively on the first embrace block (10) and the second embrace block (11), and clamping tooth surfaces (10.4, 11.4) fitted to the clamping teeth (3.3) are respectively disposed on bottom surfaces of the U-shaped grooves (10.3, 11.3); in a locked state, the first embrace block (10) and the second embrace block (11) embrace the ejection rod (3) and the clamping tooth surfaces (10.4, 11.4) are respectively fitted to the clamping teeth (3.3) of the embrace segment (3.2); in an unlocked state, the first embrace block (10) and the second embrace block (11) separate from the ejection rod (3), and the ejection rod (3) is movable between the two opposed U-shaped grooves (10.3, 11.3).

8. The curtain drilling-free electric mounting device of claim 3, wherein the telescoping adjusting module further comprises a second spring (6), and the second spring (6) is sleeved on the ejection rod (3) and located between the first slide block (8) and the second slide block (9); the first spring (5) has a smaller elastic force than the second spring (6).

9. The curtain drilling-free electric mounting device of claim 3, wherein a first signal switch (14) is disposed at an end of the first slide block (8) close to the electric drive module (2), and a second signal switch (15) is disposed at an end of the first slide block (8) close to the second slide block (9); the first signal switch (14) is used to sense a travel position of the first slide block (8) for retreating unlocking and the second signal switch (15) is used to sense a travel position of the first slide block (8) for advancing locking.

10. The curtain drilling-free electric mounting device of claim 1, wherein the electric drive module (2) is a motor.

11. Atop beam mounting assembly, wherein it comprises a top beam (16); one end of the top beam (16) is connected with the curtain drilling-free electric mounting device of claim 1, and the other end of the top beam (16) is connected with a sealing cover (17).
